(19) United States
(12) Patent Application Publication
(10) Pub. No.: US 2025/0052674 A1
(43) Pub. Date: Feb. 13, 2025

(54) DERIVING INTERFACIAL TENSION FROM FOURIER-TRANSFORM INFRARED SPECTROSCOPY

(71) Applicant: Schlumberger Technology Corporation, Sugar Land, TX (US)

(72) Inventors: Mohammed AL-HAMAD, Dhahran (SA); Wael ABDALLAH, Sugar Land, TX (US); Azizah ALRADHWAN, Dhahran (SA)

(21) Appl. No.: 18/720,359

(22) PCT Filed: Mar. 2, 2022
(86) PCT No.: PCT/US2022/018423

§ 371 Date: Jun. 14, 2024

(51) Int. Cl. G01N 21/3577; G01N 13/02; G01N 21/35; G01N 21/552

(52) U.S. Cl. CPC G01N 21/3577; G01N 13/02; G01N 21/552; G01N 2021/3595

(57) ABSTRACT

The present disclosure is directed to an improved process that measures IFT of petroleum reservoir fluids (i.e., crude oil) using Fourier-Transform Infrared Spectroscopy (FTIR) measurements. FTIR spectra of a petroleum reservoir fluid sample are measured and processed to generate FTIR data that characterizes or accounts for the surface-active species of the petroleum reservoir fluid sample. The resulting FTIR data is input to a predefined correlation function that calculates IFT of the petroleum reservoir fluid sample given the FTIR data. This new technique helps minimize the time for experiment preparation and stabilization.

### FIELD

The present disclosure relates to techniques for measuring fluid properties, such as interfacial tension (IFT), of petroleum reservoir fluids (i.e., crude oil samples).

### BACKGROUND

IFT of petroleum reservoir fluids (i.e., crude oil) is a property that governs the multiphase flow of the petroleum reservoir fluids in the reservoir and therefore production of the petroleum reservoir fluids. Conventionally, IFT is measured in the laboratory after downhole sampling of the petroleum reservoir fluids or calculated based on correlations. The correlations are typically based on pure hydrocarbons and not complex reservoir crude oil. Measuring IFT of petroleum reservoir fluids in a laboratory is very sensitive and can suffer from quality issues due to contamination. Furthermore, measuring IFT of petroleum reservoir fluids in a laboratory usually takes a long time for the measurement to reach stability.

### SUMMARY

The present disclosure provides an improved process that measures IFT of petroleum reservoir fluids (i.e., crude oil) using Fourier-Transform Infrared Spectroscopy (FTIR) measurements. FTIR spectra of a petroleum reservoir fluid sample are measured and processed to generate FTIR data that characterizes or accounts for the surface-active species of the petroleum reservoir fluid sample. The resulting FTIR data is input to a predefined correlation function that calculates IFT of the petroleum reservoir fluid sample given the FTIR data. This new technique helps minimize the time for experiment preparation and stabilization.

In embodiments, the calculated value of interfacial tension of the petroleum reservoir fluid sample can be stored and/or output for characterizing the petroleum reservoir fluid sample.

In embodiments, the FTIR spectrometer can be configured with an Attenuated Total Reflectance (ATR) accessory.

In embodiments, the processing of the FTIR spectra can involve obtaining a corrected FTIR spectra by subtracting a baseline FTIR spectra from the measured FTIR spectra.

In embodiments, the measured FTIR spectra can cover a first wavenumber range between 3080 cm-1 to 2600 cm-1 as well as a second wavenumber range between 1750 cm-1 to 1550 cm-1.

In embodiments, the FTIR data can include a first FTIR parameter and a second FTIR parameter, wherein the first FTIR parameter corresponds to the first wavenumber range between 3080 cm-1 to 2600 cm-1, and wherein the second FTIR parameter corresponds to the second wavenumber range between 1750 cm-1 to 1550 cm-1.

In embodiments, the first FTIR parameter can be calculated by integrating FTIR spectra over the first wavenumber range between 3080 cm-1 to 2600 cm-1, and the second FTIR parameter can be calculated by integrating FTIR spectra over the second wavenumber range between 1750 cm-1 to 1550 cm-1.

In embodiments, the integration of the FTIR spectra over both the first wavenumber range and the second wavenumber range involve integration of a corrected FTIR spectra obtained by subtracting a baseline FTIR spectra from the measured FTIR spectra.

In embodiments, the first FTIR parameter can represent concentration of CH₃ groups, CH₂ groups and ═CH double bond groups in the petroleum reservoir fluid sample, and the second FTIR parameter can represent concentration of carbonyl groups and alkene groups in the petroleum reservoir fluid sample.

In embodiments, the predefined correlation function can take the form

$$IFT = [ integrated area 3080 - 2600 in FTIR ] \times {[ integrated area 1750 - 1550 in FTIR ]}^{\frac{{ρ}_{w}}{{ρ}_{o}}} ,$$

where IFT is the IFT for the petroleum reservoir fluid sample at ambient conditions, [integrated area 1750-1550 in FTIR] is the area under peaks in FTIR spectra that fall within the first wavenumber range between 1750-1550 cm⁻¹, [integrated area 3080-2600 in FTIR] is the area under peaks in FTIR spectra that fall within the second wavenumber range between 3080-2600 cm⁻¹, and ρ_{w} and ρₒ are the density of water and oil, respectively.

In embodiments, the storing or outputting can involve storing the value of interfacial tension for the petroleum reservoir fluid sample in electronic form, displaying or printing the value of interfacial tension for the petroleum reservoir fluid sample, or communicating the value of interfacial tension for the petroleum reservoir fluid sample.

In embodiments, the petroleum reservoir fluid sample can be a crude oil sample at ambient conditions, and the value of interfacial tension for the petroleum reservoir fluid sample calculated by the predefined correlation function represents interfacial tension of the crude oil sample at ambient conditions.

In embodiments, the petroleum reservoir fluid sample can be a dead oil sample at ambient conditions, and the value of interfacial tension for the petroleum reservoir fluid sample calculated by the predefined correlation function represents interfacial tension of the dead oil sample at ambient conditions.

In embodiments, the method can be used to measure the IFT for a dead oil sample based on FTIR measurements of the dead oil sample with minimal sample preparation. The dead oil sample is a petroleum reservoir fluid sample at sufficiently low pressure such that it contains no dissolved gas. The resulting IFT of the dead oil sample can be used as an input to another correlation function (such as the correlation function described in U.S. Pat. No.: 10,613,251) to calculate IFT for a corresponding live oil sample at reservoir conditions (i.e., where the petroleum reservoir fluid sample is at elevated temperature and pressure and contains dissolved gas in solution that may be released from solution at surface conditions).

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a schematic illustration of FTIR measurements on a petroleum reservoir fluid sample performed by an FTIR spectrometer configured with an Attenuated Total Reluctance (ATR) accessory;

FIG. 2 is a flowchart illustrating a process that calculate the IFT of a petroleum reservoir fluid sample from FTIR measurements on the petroleum reservoir fluid sample in accordance with the present disclosure;

FIG. 3 are plots that depict an example of the measured FTIR spectra for a petroleum reservoir fluid sample and a baseline FTIR spectra, which are collected and recorded as part of the process of FIG. 2;

FIG. 4 are plots of the corrected FTIR spectra derived from measurements collected and recorded by an FTIR spectrometer for a number of petroleum reservoir fluid samples of varying API;

FIG. 5 is a plot of measured IFT values versus calculated IFT values for a number of petroleum reservoir fluid samples of varying API. The measured IFT values were obtained using standard laboratory techniques. The calculated IFT values were determined using the process of FIG. 2. The plot confirms the robustness of the process of FIG. 2 in calculating the IFT of the petroleum reservoir fluid samples;

FIG. 6 is a flowchart illustrating a process that calculates the IFT of a live oil sample at reservoir conditions from FTIR measurements on a corresponding dead oil sample in accordance with the present disclosure; and

FIG. 7 is a schematic diagram of a computing system.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

Knowledge of IFT of petroleum reservoir fluids plays an important role in the evaluation of reservoir potential and its performance. It is also an important property for dynamic reservoir performance simulation. It controls fluid distribution and flow in porous media, as it is linearly proportional to capillary pressure, P_{c} as shown in Eq. 1 assuming the porous medium is represented by cylindrical tubes:

$${P}_{c} = \frac{2 {γ}_{ow} cos θ}{r} \qquad ( 1 )$$

where P_{c} is the capillary pressure, γ_{ow} is the IFT between hydrocarbons and water, θ is the wetting angle, and r is the pore throat radius.

Since P_{c} determines fluid distribution at equilibrium, one application of IFT is in oil reserve calculation. The height of the hydrocarbon column is calculated by equating the capillary pressure P_{c} (Eq.1) with buoyancy pressure, resulting in:

$$H = \frac{Pc}{g ( {ρ}_{w} - {ρ}_{o} )} = \frac{2 {γ}_{ow} cos θ}{rg ( {ρ}_{w} - {ρ}_{o} )} \qquad ( 2 )$$

where H is the hydrocarbon column height above free water level, g is the gravity constant, and ρ_{w} and ρₒ are density of water and hydrocarbons, respectively.

Fluid flow in porous media can be determined by the balance between the capillary pressure P_{c} and a driving force or displacing viscous force, as defined by a capillary number N_{c}. The capillary number N_{c} is defined as the ratio between viscous and capillary forces as shown in Eq.3:

$${N}_{c} = \frac{{μ}_{w} {V}_{w}}{{ϑγ}_{ow}} \qquad ( 3 )$$

where N_{c} is the capillary number, μ_{w} is the viscosity of aqueous or displacing phase, V_{w} is the flow rate of the displacing phase and ∂ is the effective porosity of formation.

Importantly, determining IFT (γ_{ow}) as part of Eqn. 1 is needed to determine the capillary pressure P_{c} and then determine the initial water saturation (Eqns. 1 and 2) and the residual oil saturation and oil displacement efficiency, i.e., oil recovery (Eqn. 3).

For more than a century, a variety of techniques have been developed and used to measure IFT between immiscible fluid phases. These techniques involve IFT measurements either with an optical or force tensiometer, such as pendant drop, ring tensiometry and laser-light-scattering techniques (see Andreas, J. M., Hauser, A., Tucker, W. B., 1938, “Boundary tension by pendant drops,” J. Phys. Chem. 42, 1001-1019; Haniff, M. S., Pearce, A. J., 1990, “Measuring Interfacial Tensions in a Gas-Condensate System with Laser-Light-Scattering Technique,” SPE Res. Eng. 5, 589-594, SPE-19025-PA; Huh, C., Mason S. G., 1975, “A rigorous theory of ring tensiometry,” Colloid Polym. Sci. 253, 566-580; Nouy, P. L. du., 1919, “A new apparatus for measuring surface tension,” J. Gen. Physiol. 1, 521-524; and Zuidema, H., Waters, G., 1941, “Ring method for the determination of interfacial tension,” Ind. Eng. Chem. Anal. Ed. 13, 312-313). All these measurement methods require long experiment preparation and stabilization.

In addition, several correlations were developed to estimate the hydrocarbon/water IFT (See Firoozabadi, A., Ramey, H.J., 1988, “Surface tension of water-hydrocarbon systems at reservoir conditions,” J. Can. Pet. Technol. 27, 41-48; Sutton, R.P., 2009,” An Improved Model for Water-Hydrocarbon Surface Tension at Reservoir Conditions,” SPE Annual Technical Conference and Exhibition SPE-124968-MS, 1-18; and Zeppieri, S., Rodriguez, J., López de Ramos, A.L., 2001, “Interfacial Tension of Alkane+Water Systems. J. Chem. Eng. Data 46, 1086-1088). These correlations, however, are based on pure hydrocarbon and found to fail in estimating IFT of complex fluids such as petroleum reservoir fluids that can include a mixture of hydrocarbons, a water-based component (e.g., brine), and miscellaneous organic components.

The currently used correlations overestimate IFT values, which can result in an overestimated reserve (Eq. 2) and underestimation of oil recovery rates (Eq. 3) by up to 25%. Such deviations can have a significant impact on reservoir evaluations (both reserves and recoveries) and therefore on asset economics.

Petroleum reservoir fluids (i.e., crude oils) typically contain a large number of components. Among them, surface-active species, such as carboxylic acids, can dominate the properties of the oil/water interface. Even in small quantities, the surface-active species can have a significant effect on the IFT of petroleum reservoir fluids. Because the currently used correlations do not specifically account for the surface-active components in petroleum reservoir fluids, the currently used correlations are not suited to accurately measure the IFT of petroleum reservoir fluids. It is, however, a challenge to estimate the concentration of these surface-active components in petroleum reservoir fluids, making it challenging to correct for their influence.

In accordance with the present disclosure, FTIR measurements of a petroleum reservoir fluid sample can be processed to generate FTIR data that represents or corresponds to the concentration of surface-active components in the petroleum reservoir fluid sample. Such FTIR data is used as input to a correlation function that correlates the FTIR data with a measured IFT of the petroleum reservoir sample at ambient conditions. From the results of measurements, the measured IFT of a number of petroleum reservoir fluid samples was found to correlate very well with FTIR absorption peaks of the carbonyl and alkene groups of the petroleum reservoir fluid samples, and with the hydrocarbon content of the petroleum reservoir fluid samples. In this manner, the method can effectively (i.e., with very good accuracy) predict the IFT of a petroleum reservoir fluid sample from basic FTIR measurements on the petroleum reservoir fluid sample.

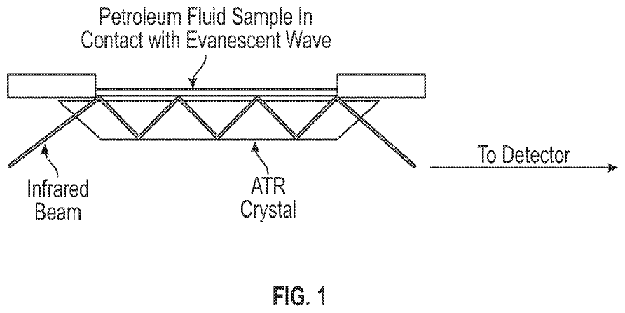

In embodiments, the FTIR measurements of the petroleum reservoir fluid sample can be measured and recorded by an FTIR spectrometer configured with an Attenuated Total Reflectance (ATR) accessory. The ATR accessory operates by measuring changes that occur in a totally internally reflected infrared beam when the beam comes into contact with the petroleum reservoir fluid sample (i.e., crude oil sample) as shown in FIG. 1. In this configuration, an infrared beam is directed onto an optically dense ATR crystal with a high refractive index at a certain angle. This internal reflectance creates an evanescent wave that extends beyond the surface of the crystal into the petroleum reservoir fluid sample that contacts the crystal. This evanescent wave protrudes only a few microns (0.5μ-5μ) beyond the crystal surface and into the petroleum reservoir fluid sample. In regions of the infrared spectrum where the petroleum reservoir fluid sample absorbs energy, the evanescent wave will be attenuated. The attenuated energy from the evanescent wave is passed back to the IR beam, which then exits the opposite end of the crystal and is passed to the detector of the IR spectrometer. The FTIR spectrometer measures FTIR spectra (i.e., intensity of absorption as a function of wavenumber) of the petroleum reservoir fluid sample. As with all FTIR measurements, baseline, or background FTIR spectra can be measured and recorded from a clean ATR crystal. The ATR crystal is typically cleaned using a solvent.

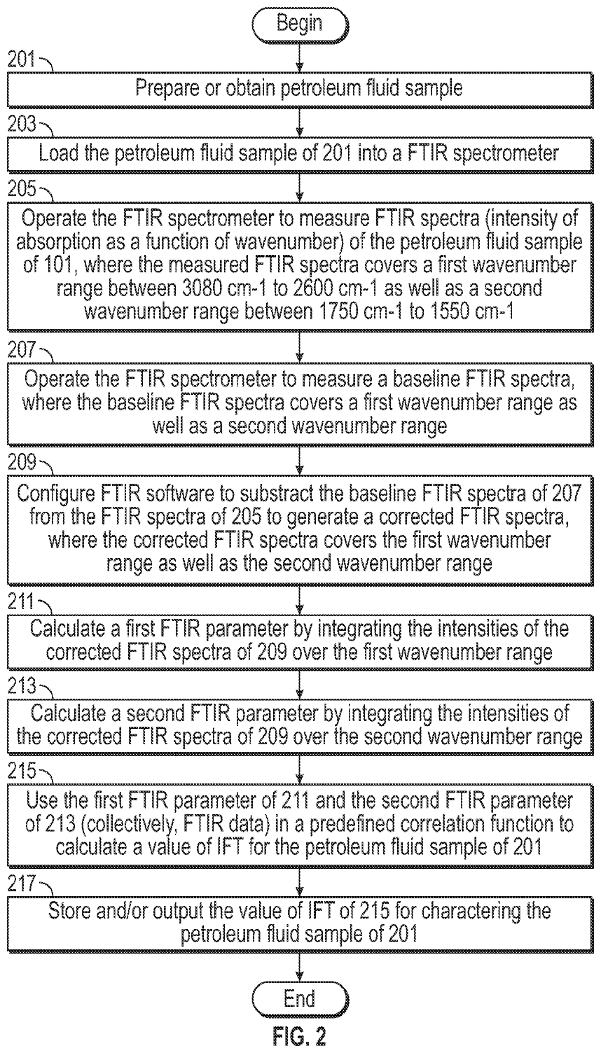

FIG. 2 illustrates a process that calculates the IFT of a petroleum reservoir fluid sample from FTIR measurements on the petroleum reservoir fluid sample. The process begins in block 201 by preparing or obtaining a petroleum reservoir fluid sample (i.e., i.e., crude oil sample). In block 203, the petroleum reservoir fluid sample of 201 is loaded into an FTIR spectrometer. In embodiments, the FTIR spectrometer can be configured with an Attenuated Total Reflectance (ATR) accessory as illustrated in FIG. 1. Alternatively, another FTIR spectrometer can be used, if desired.

In block 205, the FTIR spectrometer is operated to measure FTIR spectra (intensity of absorption as a function of wavenumber) of the petroleum reservoir fluid sample of 201, where the measured FTIR spectra covers a first wavenumber range between 3080 cm-1 to 2600 cm-1 as well as a second wavenumber range between 1750 cm-1 to 1550 cm-1.

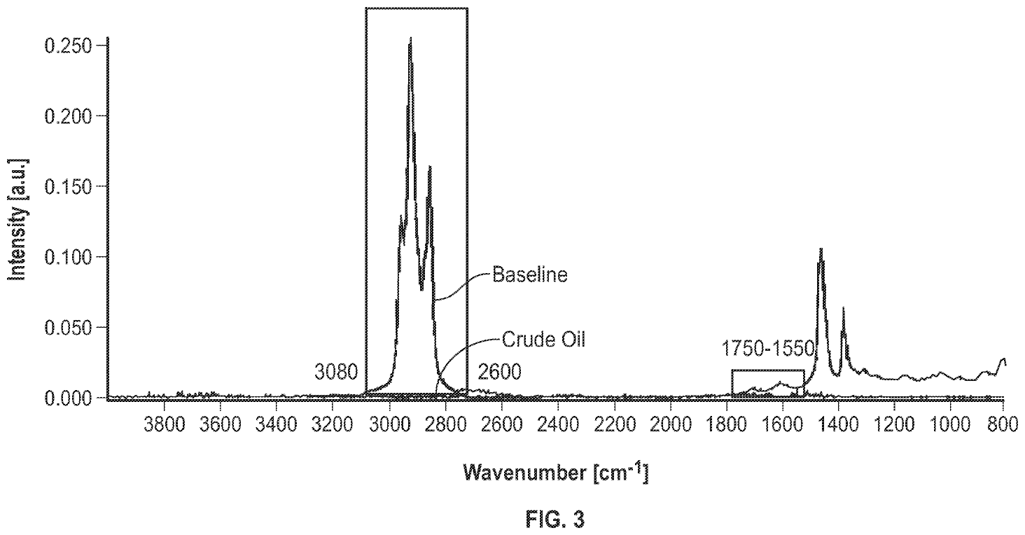

In block 207, the FTIR spectrometer is operated to measure a baseline FTIR spectra, where the baseline FTIR spectra covers the first wavenumber range and the second wavenumber range. In embodiments, the baseline FTIR spectra can be measured and recorded from a clean ATR crystal with air at room temperature (e.g., 25° C.). The measured FTIR spectra for the petroleum reservoir fluid sample (block 205) and the baseline FTIR spectra (block 207) can both be measured with a preset scanning time, such as 16 s. An example of the measured FTIR spectra for the petroleum reservoir fluid sample (block 205) and the baseline FTIR spectra (block 207) is shown in FIG. 3.

In block 209, FTIR software is configured to subtract the baseline FTIR spectra (block 207) from the measured FTIR spectra for the petroleum reservoir fluid sample (block 205) to generate “corrected” FTIR spectra for the petroleum reservoir fluid sample. The peaks in the corrected FTIR spectra indicate structural and functional groups of the petroleum reservoir fluid sample.

FTIR software can be further configured to calculate (for example, by integration) the area under peaks in the corrected FTIR spectra that fall within one or more predefined wavenumber ranges, where the one or more predefined wavenumber ranges correspond to specific functional groups (i.e., specific functional groups for surface-active components in the petroleum reservoir fluid sample).

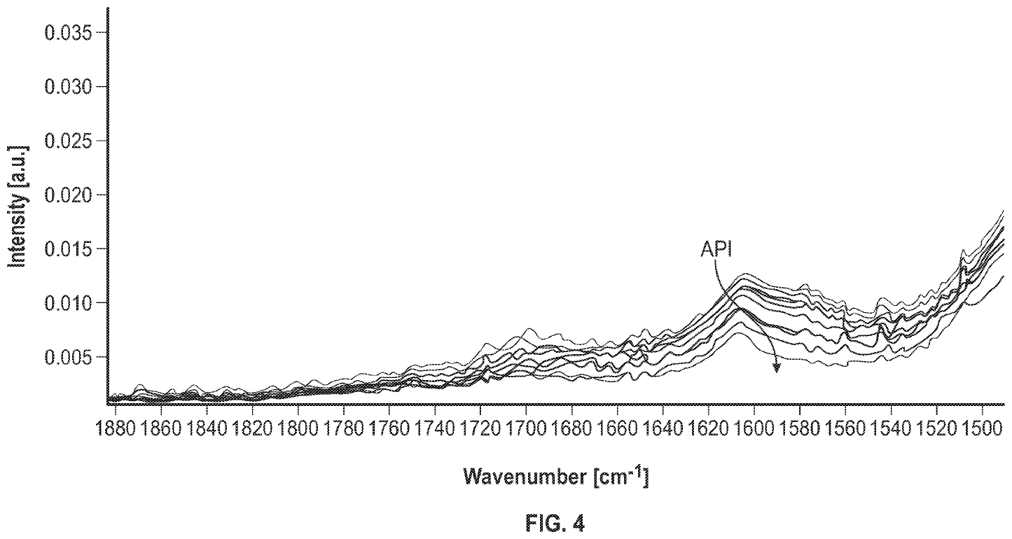

For example, in one embodiment, the FTIR software can be configured to calculate (by integration) the area under peaks in the corrected FTIR spectra that fall within the first wavenumber range between 1750-1550 cm⁻¹ in block 211. This calculated area is referred to as the first FTIR parameter in FIG. 2. The FTIR software can be further configured to calculate (by integration) the area under peaks in the corrected FTIR spectra that fall within the second wavenumber range between 3080-2600 cm⁻¹ in block 213. This calculated area is referred to as the second FTIR parameter in FIG. 2. The absorption peaks of the corrected FTIR spectra within the first wavenumber range between 1750-1550 cm⁻¹ represent the stretching vibrations of carbonyl group, C—O at about 1680 cm⁻¹ and alkene group, C═C at about 1590 cm⁻¹. It was observed that these peaks either increase or decrease based on the composition of the petroleum reservoir fluid sample. More specifically, the higher the API of the petroleum reservoir fluid sample, the lower the peak in the corrected FTIR spectra as shown in FIG. 4. In this manner, the increase in peak for C═O and C═C resulted in an increase in the integrated area, and vice versa. The absorption peaks of the corrected FTIR spectra within the second wavenumber range between 3080-2600 cm⁻¹ represent the C—H stretching vibrations of CH₃ and CH₂ groups as well as the double bonds, ═CH. In this manner, the areas under the peaks in the corrected FTIR spectra (or first and second FTIR parameters) of blocks 211 and 213 represent or correspond to the concentration of surface-active components in the petroleum reservoir fluid sample.

In block 215, the calculated area(s) under such peaks in the corrected FTIR spectra (or the FTIR parameter(s)) can then be used as FTIR data that represents or corresponds to the concentration of surface-active components in the petroleum reservoir fluid sample, which is input to a predefined correlation function to determine a value of IFT for the petroleum reservoir fluid sample of 201. For example, the predefined correlation function can take the form of (Eq.4) below which predicts the IFT for the petroleum reservoir fluid sample at ambient conditions:

$$IFT = [ integrated area 3080 - 2600 in FTIR ] \times {[ integrated area 1750 - 1550 in FTIR ]}^{\frac{{ρ}_{w}}{{ρ}_{o}}} \qquad ( 4 )$$

where IFT is the IFT for the petroleum reservoir fluid sample at ambient conditions, [integrated area 1750-1550 in FTIR] is the area under peaks in the corrected FTIR spectra that fall within the first wavenumber range between 1750-1550 cm⁻¹ (or first FTIR parameter), [integrated area 3080-2600 in FTIR] is the area under peaks in the corrected FTIR spectra that fall within the second wavenumber range between 3080-2600 cm⁻¹ (or second FTIR parameter), and ρ_{w} and ρₒ are the density of water and oil, respectively.

In block 217, the value of IFT for the petroleum reservoir fluid sample as determined in 215 can be stored and/or output for characterizing the petroleum reservoir fluid sample of 201. Such operations can involve storing the value of IFT for the petroleum reservoir fluid sample in electronic form, displaying or printing the value of IFT for the petroleum reservoir fluid sample, or communicating the value of IFT for the petroleum reservoir fluid sample.

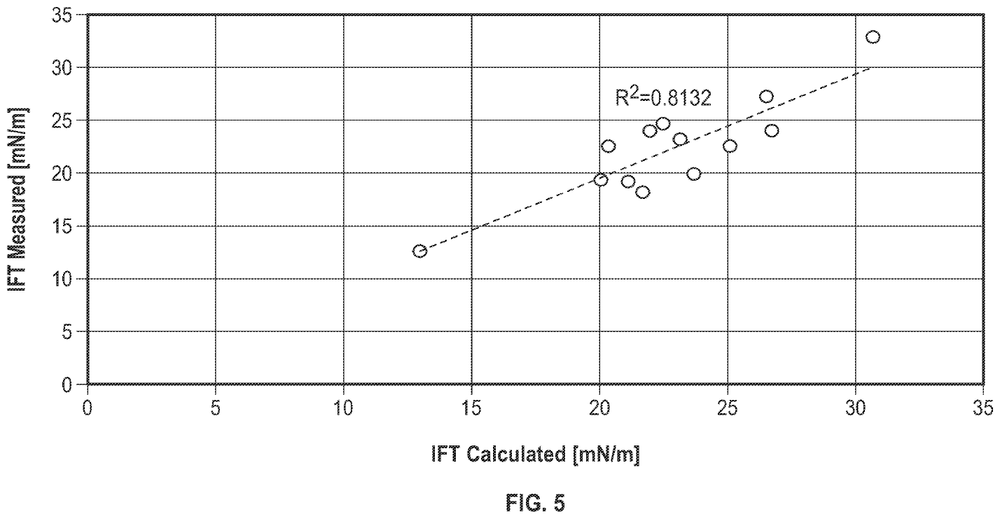

The predefined correlation function of Eqn. (4) was tested and validated on number of crude oils of different API, and it shows its robustness in calculating the IFT of the crude oils as shown in FIG. 5.

### IFT of Live Oil

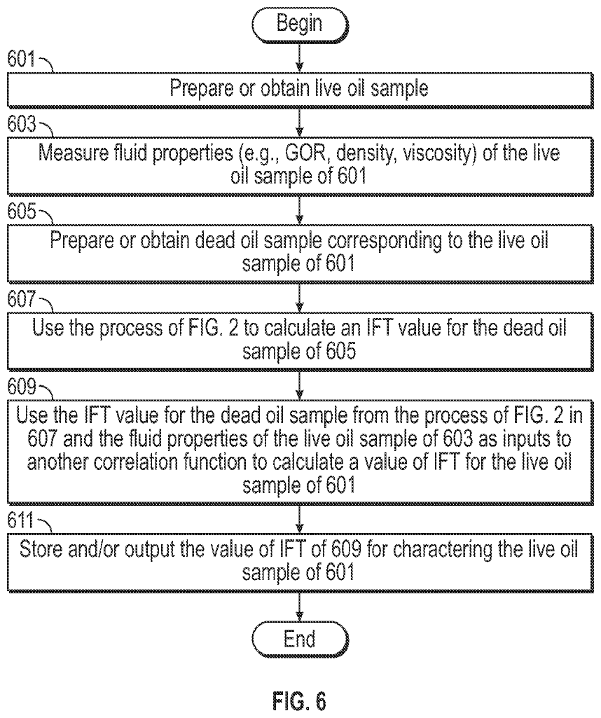

In embodiments, the IFT of a dead oil sample from FTIR measurements on the dead oil sample as determined from the process of FIG. 2 can be used as input to another correlation function that calculates IFT of corresponding live oil at reservoir conditions. FIG. 6 illustrates a process that calculates the IFT of live oil at reservoir conditions from the IFT of a corresponding dead oil sample as determined from the process of FIG. 2. The process begins in block 601 by preparing or obtaining a live oil sample. For example, the live oil sample can be obtained by downhole fluid sampling.

In block 603, fluid properties (e.g., GOR, density, viscosity) of the live oil sample of 601 can be measured and stored in electronic form. The fluid properties can be measured by downhole fluid analysis (e.g., by a downhole fluid analyser (DFA)), flash analysis (single or multistage) using an onsite separator, or through PVT laboratory analysis of the live oil sample under the downhole pressure and temperature conditions.

In block 605, a dead oil sample corresponding to the live oil sample is prepared or obtained. For example, the dead oil sample can be prepared by depressurization of the live oil sample (or part thereof) to ambient conditions and allowing any dissolved gas and volatile components to escape from the sample.

In block 607, the process of FIG. 2 is used to determine an IFT value for the dead oil sample of 605.

In block 609, the IFT value for the dead oil sample from the process of FIG. 2 in 607 and the fluid properties of the live oil sample of 603 are used as inputs to another correlation function to calculate a value of IFT for the live oil sample of 601. An example of such correlation function is described in U.S. Pat. No.: 10,613,251, herein incorporated by reference in its entirety. The IFT for the live oil sample as determined from the correlation function can calculate IFT of the live oil sample at reservoir conditions (i.e., where the live oil is at elevated temperature and pressure and contains dissolved gas in solution that may be released from solution at surface conditions).

In block 611, the value of IFT for live oil sample as determined in 609 can be stored and/or output for characterizing the live oil sample of 601. Such operations can involve storing the value of IFT for the live oil sample in electronic form, displaying or printing the value of IFT for the live oil sample, or communicating the value of IFT for the live oil sample.

### Example Computing System

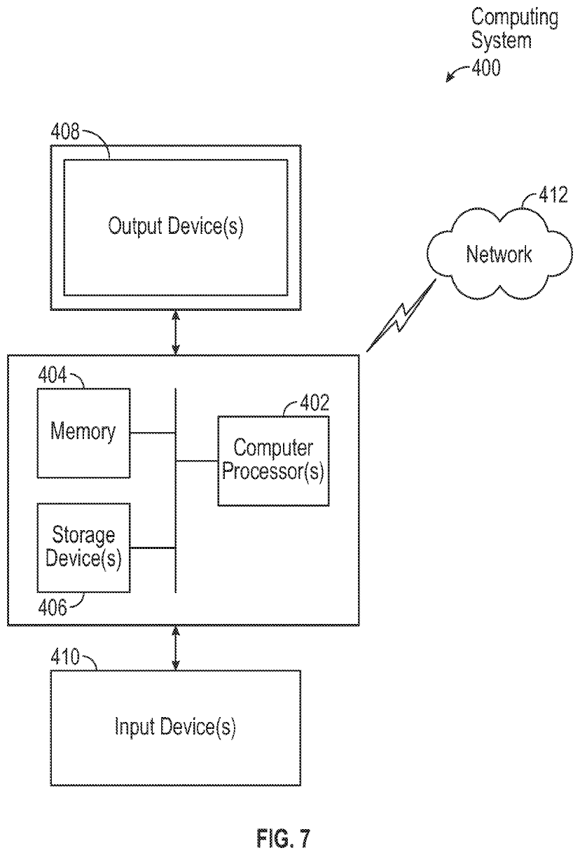

Embodiments of the present disclosure may be implemented on a computing system. Any combination of mobile, desktop, server, embedded, or other types of hardware may be used. For example, as shown in FIG. 7, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer-readable program code to perform embodiments of the invention may be stored, in whole or in part, temporarily or permanently, on a non-transitory computer-readable medium such as a CD, DVD, storage device, a diskette, a tape, flash memory, physical memory, or any other computer-readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

Although the preceding description has been described herein with reference to particular means, materials, and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

There have been described and illustrated herein several embodiments of methods and systems that measure IFT of petroleum reservoir fluids (i.e., crude oils) using Fourier-Transform Infrared Spectroscopy (FTIR) measurements. While particular embodiments of the invention have been described, it is not intended that the invention be limited thereto, as it is intended that the invention be as broad in scope as the art will allow and that the specification be read likewise. It will therefore be appreciated by those skilled in the art that modifications could be made to the provided invention without deviating from its spirit and scope as claimed.

What is claimed is:

1. A method comprising:
preparing or obtaining a petroleum reservoir fluid sample;
operating an FTIR spectrometer to measure FTIR spectra of the petroleum reservoir fluid sample;
processing the measured FTIR spectra of the petroleum reservoir fluid sample to obtain FTIR data that characterizes or accounts for surface-active species of the petroleum reservoir fluid sample;
using the FTIR data as input to a predefined correlation function that calculates a value of interfacial tension of the petroleum reservoir fluid sample; and
storing or outputting the calculated value of interfacial tension of the petroleum reservoir fluid sample for characterizing the petroleum reservoir fluid sample.

2. The method of claim 1, wherein:
the FTIR spectrometer is configured with an Attenuated Total Reflectance (ATR) accessory.

3. The method of claim 1, wherein:
the processing involves obtaining a corrected FTIR spectra by subtracting a baseline FTIR spectra from the measured FTIR spectra.

4. The method of claim 1, wherein:
the measured FTIR spectra covers a first wavenumber range between 3080 cm-1 to 2600 cm-1 as well as a second wavenumber range between 1750 cm-1 to 1550 cm-1.

5. The method of claim 4, wherein:
the FTIR data includes a first FTIR parameter and a second FTIR parameter, wherein the first FTIR parameter corresponds to the first wavenumber range between 3080 cm-1 to 2600 cm-1, and wherein the second FTIR parameter corresponds to the second wavenumber range between 1750 cm-1 to 1550 cm-1.

6. The method of claim 5, wherein:
the first FTIR parameter is calculated by integrating FTIR spectra over the first wavenumber range between 3080 cm-1 to 2600 cm-1, and
the second FTIR parameter is calculated by integrating FTIR spectra over the second wavenumber range between 1750 cm-1 to 1550 cm-1.

7. The method of claim 6, wherein:
the integration of the FTIR spectra over both the first wavenumber range and the second wavenumber range involve integration of a corrected FTIR spectra obtained by subtracting a baseline FTIR spectra from the measured FTIR spectra.

8. The method of claim 5, wherein:
the first FTIR parameter represents concentration CH₃ groups, CH₂ groups and ═CH double bond groups in the petroleum reservoir fluid sample; and
the second FTIR parameter represents concentration of carbonyl groups and alkene groups in the petroleum reservoir fluid sample.

9. The method of claim 5, wherein:
the predefined correlation function is of the form
$$IFT = [ integrated area 3080 - 2600 in FTIR ] \times {[ integrated area 1750 - 1550 in FTIR ]}^{\frac{{ρ}_{w}}{{ρ}_{o}}} ,$$
where IFT is the IFT for the petroleum reservoir fluid sample at ambient conditions, [integrated area 1750-1550 in FTIR] is the area under peaks in FTIR spectra that fall within the first wavenumber range between 1750-1550 cm⁻¹, [integrated area 3080-2600 in FTIR] is the area under peaks in FTIR spectra that fall within the second wavenumber range between 3080-2600 cm⁻¹, and ρ_{w} and ρₒ are the density of water and oil, respectively

10. The method of claim 1, wherein:
the storing or outputting involves storing the value of interfacial tension for the petroleum reservoir fluid sample in electronic form, displaying or printing the value of interfacial tension for the petroleum reservoir fluid sample, or communicating the value of interfacial tension for the petroleum reservoir fluid sample.

11. The method of claim 1, wherein:
the petroleum reservoir fluid sample comprises a crude oil sample at ambient conditions; and
the value of interfacial tension for the petroleum reservoir fluid sample calculated by the predefined correlation function represents interfacial tension of the crude oil sample at ambient conditions.

12. The method of claim 1, wherein:
the petroleum reservoir fluid sample comprises a dead oil sample at ambient conditions; and
the value of interfacial tension for the petroleum reservoir fluid sample calculated by the predefined correlation function represents interfacial tension of the dead oil sample at ambient conditions.

13. The method of claim 12, further comprising:
correcting the value representing interfacial of the dead oil sample at ambient conditions to a value representing interfacial tension for live oil at reservoir conditions.

14. The method of claim 13, further comprising:
using the value of interfacial tension for live oil at reservoir conditions for evaluation of reservoir potential or reservoir performance.

15. A method comprising:
preparing or obtaining a live oil sample;
measuring fluid properties of the live oil sample;
preparing or obtaining a dead oil sample corresponding to the live oil sample;
operating an FTIR spectrometer to measure FTIR spectra of the dead oil sample;
processing the measured FTIR spectra of the dead oil sample to obtain FTIR data that characterizes surface active species of the dead oil sample;
using the FTIR data as input to a predefined first correlation function that calculates a value of interfacial tension of the dead oil sample;
using the value of interfacial tension of the dead oil sample and the fluid properties of the live oil sample as input to a predefined second correlation function that calculates a value of interfacial tension of the live dead oil sample to petroleum reservoir fluid sample; and
storing or outputting the calculated value of interfacial tension of the live oil sample for characterizing the live oil sample.

16. The method of claim 15, wherein:
the FTIR spectrometer is configured with an Attenuated Total Reflectance (ATR) accessory.

17. The method of claim 15, wherein:
the processing involves obtaining a corrected FTIR spectra by subtracting a baseline FTIR spectra from the measured FTIR spectra.

18. The method of claim 15, wherein:
the measured FTIR spectra covers a first wavenumber range between 3080 cm-1 to 2600 cm-1 as well as a second wavenumber range between 1750 cm-1 to 1550 cm-1.

19. The method of claim 18, wherein:
the FTIR data includes a first FTIR parameter and a second FTIR parameter, wherein the first FTIR parameter corresponds to the first wavenumber range between 3080 cm-1 to 2600 cm-1, and wherein the second FTIR parameter corresponds to the second wavenumber range between 1750 cm-1 to 1550 cm-1.

20. The method of claim 19, wherein:
the first FTIR parameter is calculated by integrating FTIR spectra over the first wavenumber range between 3080 cm-1 to 2600 cm-1, and
the second FTIR parameter is calculated by integrating FTIR spectra over the second wavenumber range between 1750 cm-1 to 1550 cm-1.

21. The method of claim 20, wherein:
the integration of the FTIR spectra over both the first wavenumber range and the second wavenumber range involve integration of a corrected FTIR spectra obtained by subtracting a baseline FTIR spectra from the measured FTIR spectra.

22. The method of claim 19, wherein:
the first FTIR parameter represents concentration CH₃ groups, CH₂ groups and ═CH double bond groups in the dead oil sample; and
the second FTIR parameter represents concentration of carbonyl groups and alkene groups in the dead oil sample.

23. The method of claim 19, wherein:
the predefined first correlation function is of the form
$$IFT = [ integrated area 3080 - 2600 in FTIR ] \times {[ integrated area 1750 - 1550 in FTIR ]}^{\frac{{ρ}_{w}}{{ρ}_{o}}} ,$$
where IFT is the IFT for the dead oil sample at ambient conditions, [integrated area 1750-1550 in FTIR] is the area under peaks in FTIR spectra that fall within the first wavenumber range between 1750-1550 cm⁻¹, [integrated area 3080-2600 in FTIR] is the area under peaks in FTIR spectra that fall within the second wavenumber range between 3080-2600 cm⁻¹, and ρ_{w} and ρₒ are the density of water and oil, respectively

24. The method of claim 15, wherein:
the storing or outputting involves storing the value of interfacial tension for the live oil sample in electronic form, displaying or printing the value of interfacial tension for the live oil sample, or communicating the value of interfacial tension for the live oil sample.

25. The method of claim 15, further comprising:
using the value of interfacial tension for the live oil sample for evaluation of reservoir potential or reservoir performance.
